(19) United States
(12) Patent Application Publication
(10) Pub. No.: US 2025/0218179 A1
(43) Pub. Date: Jul. 3, 2025

(54) PERFORMING MACHINE LEARNING TASKS BY PROCESSING IMAGES AS VIDEOS

(71) Applicants: DeepMind Technologies Limited, London (GB); GDM Holding LLC, London (GB)

(72) Inventors: Antoine Miech, London (GB); Abhanshu Sharma, Zurich (CH)

(21) Appl. No.: 19/009,187

(22) Filed: Jan. 3, 2025

Related U.S. Application Data
(60) Provisional application No. 63/617,262, filed on Jan. 3, 2024.

(51) Int. Cl. G06V 20/40; G06V 10/82; G06V 10/96

(52) U.S. Cl. CPC G06V 20/46; G06V 10/82; G06V 10/96

(57) ABSTRACT

A method performed by one or more data processing apparatus. The method comprises receiving an image item; obtaining a mask for selecting portions of the image item; and generating, from the image item, one or more video item comprising a respective one or more sequences of image frames. Each image frame comprises a respective portion of the image item selected using the mask. For each image sequence, the mask is translated incrementally over the image item to select the respective portions of the image item for successive image frames in the sequence. The method further comprises performing a machine learning task by processing the one or more video items using a machine learning model.

### CROSS-REFERENCE TO RELATED APPLICATION

This application claims priority to U.S. Provisional Application No. 63/617,262, filed on Jan. 3, 2024. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a method implemented as computer programs on one or more computers in one or more locations that can perform a machine learning task by processing an image item. More particularly, the described techniques are able to perform the machine learning task by generating one or more video items from the image item and then processing the one or more video items using a machine learning model, such as a multimodal machine learning model, to perform the machine learning task. Processing the video item(s) may allow the machine learning model to perform the machine learning task more accurately and/or efficiently compared to processing the image item directly (i.e., as an image item rather than as one or more video items).

According to a first aspect of the present disclosure, there is provided a method performed by one or more data processing apparatus. The method comprises receiving an image item; obtaining a mask for selecting portions of the image item; and generating, from the image item, one or more video item comprising a respective one or more sequences of image frames. Each image frame (or “crop” of the image item) comprises a respective portion of the image item selected using the mask. For each image sequence, the mask is translated incrementally over the image item to select the respective portions of the image item for successive image frames in the sequence. The method further comprises performing a machine learning task by processing the one or more video items using a machine learning model.

In some implementations, multiple sequences of image frames are generated from a single image item and provided to the machine learning model as a single video item comprising the multiple sequences of image frames, or as multiple video items, each video item then comprising a respective one or more of the sequences of image frames. For example, each video item can comprise a different respective sequence of image frames generated from the image item.

In some implementations, the mask can be translated incrementally over the image item along a first direction (e.g., parallel to a dimension of the image item, such as the width or height of the image item) to select the respective portions of the image item for successive image frames in the sequence. In some implementations, each sequence of frames comprises one or more pairs of image frames, each pair of image frames comprising a respective first image frame and a respective second image frame adjacent in the sequence to the first image frame. The respective portions of the image item of the first and second image frames can overlap along the first direction. Such overlapping may improve the performance of the machine learning model by allowing the machine learning model to better take into account features of the image item that span more than one of the image frames. As one example, the image item may be an image comprising text formatted as a table (i.e., tabular data) and the image frames may comprise different respective portions (e.g., rows or columns) of the table. By overlapping the image frames, the machine learning model may be better able to identify that the rows or columns are part of the same table, rather than separate tables, for example.

In some examples, each video item comprises at least a first sequence of image frames and a second sequence of image frames, the respective portions of the image item for the image frames of the second sequence being offset along a second direction from the respective portions of the image item for the image frames of the second sequence. The second direction can be perpendicular to the first direction. For example, the first direction can be along a width of the image item and the second direction can be along the height of the image item, or vice versa. In other words, the image sequence(s) can be obtained by translating the mask in more than one direction, e.g., the one or more image sequences can be obtained by performing a two-dimensional (2D) scan of the mask over the image item.

In some examples, the image item can comprise a three-dimensional image (i.e., an image item that comprises 3D pixel or voxel data across three spatial dimensions), in which case the portion of the image item of each image frame selected using the mask may correspond to a three-dimensional region (volume) of the image item, rather than a two-dimensional region (area). Each video item can then comprise a three-dimensional video obtained by translating the mask over (e.g., through) the three-dimensional image item. Alternatively, each image frame can be a two-dimensional image representing a different slice through the three-dimensional image or an average over or 2D projection of a three-dimensional region. In some examples, a three-dimensional scan of the image item can be performed to generate the one or more sequences of image frames, i.e., the mask can be translated along one, two or three perpendicular directions within the image item, e.g., to perform a 3D scan of the image item. The three-dimensional image item can be obtained by any appropriate 3D image generation or capture technique, such as volumetric capture or LIDAR. In some implementations, each image frame can overlap with at least one other image frame along each dimension of the image item.

In some implementations, the method comprises receiving a model input for processing by the machine learning model that comprises the image item, and then updating the model input by replacing the image item with the one or more video items. Performing the machine learning task by processing the one or more video items using the machine learning model can then comprise processing the updated model input using the machine learning model.

In some implementations, the machine learning model can be a multimodal machine learning model that is configured to process, depending on a model input provided to the machine learning model, a first modality input representing an image item and/or a second modality input representing one or more video items. Processing the one or more video items using the machine learning model can therefore comprise processing a model input comprising a second modality input representing the one or more video items using the machine learning model. In other words, the machine learning model can perform different processing of the model input depending on whether the model input comprises an image item or one or more video items generated from the image item (an optionally, the image item as well). For example, when processing the second modality input, the machine learning model can, when processing each of the image frames, take into account one or more other image frames in the same sequence as the image frame, e.g., other one or more image frames that that precede (or follow) the image frame in the sequence. As one example, the machine learning model can, when processing the one or more video items, apply an attention mechanism that attends to multiple image frames simultaneously.

In some implementations, the model input provided to the machine learning model can depend on a size or aspect ratio of the image item. For example, if a size of the image item is less than (or in some cases, equal to) a predetermined size, the model input may include the image item as a first modality input, whilst if the size of the image item exceeds (or in some cases, is equal to) the predetermined size, the model input may include the one or more video items as a second modality input.

In some implementations, the machine learning model is a multimodal machine learning model that processes an input including a first modality input comprising the video item and a second modality input for a modality other than video. For example, the second modality input can represent one of a text item, an audio item, or an image item. As one example, the second modality input can represent one or more text items and the machine learning model can be a vision language model configured to generate a joint embedding representing the video item and the one or more text items, and to use the joint embedding to perform the machine learning task.

In some implementations, obtaining the mask comprises determining a size for the mask based on one or more of: an aspect ratio of the image item, a minimum dimension of the image item, and a maximum size of image frame that can be processed by the machine learning model. For example, the machine learning model may be configured to receive image items of less than (or equal to) a maximum size, i.e., a maximum width and height, e.g., specified as a number of pixels, such as 768×768 pixels, 800×600 pixels, 1024×1024 pixels, etc.). The mask can then, for example, have a width and height equal to the maximum width and height for the machine learning model. The mask may alternatively be referred to as a “window” in some cases. In some implementations, the mask comprises binary values for each of the pixels in the image item that indicates whether or not the pixel should be included in the corresponding image frame.

In some other implementations, the method can comprise resizing each image frame according to a maximum size of image frame that can be processed by the machine learning model. For example, each image frame can be resized such that the width and/or height of the resized image frame matches the width and/or height of the maximum size of image frame that can be processed by the machine learning model. Enlarging portions of the image item in this way can improve the performance of the machine learning model, e.g., by “zooming in” on objects or features in the image item that might otherwise receive less attention from the machine learning model.

In some implementations, the method can comprise, prior to generating the video item, resizing the image item such that a first dimension of the resized image item is less than or equal to a corresponding first dimension of the mask. As one example, if the mask is translated incrementally over the image item along a first direction to select the respective portions of the image item for successive image frames in the sequence, then the first direction can be along a second dimension of the resized image. For example, the resized image can have a height less than or equal to the height of the mask and the mask can be translated incrementally over the image item along the width of the image item. Alternatively, the resized image can have a width less than or equal to the width of the mask and the mask can be translated incrementally over the image item along the height of the image item.

In some implementations, resizing the image item can preserve an aspect ratio of the image item. Where the first dimension of the resized image item is less than the corresponding first dimension of the mask, the resized image item may be padded with a default or null value to make the first dimension of the resized image item and the first dimension of the mask equal. In some implementations, the image item or mask may be rotated or transposed prior to resizing, e.g., such that the smaller dimension of the image item corresponds to the smaller dimension of the mask. Resizing the image may be referred to as image scaling or image resampling (e.g., downsampling), and can be performed with many common image processing libraries, such as OpenCV or scikit-image.

According to a second aspect of the present disclosure, there is provided a method performed by one or more data processing apparatus for performing a machine learning task using a multimodal machine learning model. The method may comprise: receiving an image item; and providing a model input to a multimodal machine learning model that is configured to process, depending on the model input, a first modality input representing an image item and/or a second modality input representing one or more video items, wherein: (i) if a size of the image item is less than (or in some cases, is equal to) a predetermined size, the model input includes the image item as a first modality input; and (ii) if the size of the image item exceeds (or in some cases, is equal to) the predetermined size, the model input includes one or more video items as a second modality input, the video item being obtained by converting the image item to a respective one or more sequences of image frames, each image frame comprising a (e.g., different) respective portion of the image item. The method may further comprise performing a machine learning task by using the multimodal machine learning model to process the model input.

In other words, the machine learning model may perform different processing depending on whether the model input comprises an image item and/or one or more video items generated from the image item. The size of the image item may be determined to exceed the predetermined size if a width and/or height of the image item exceeds a respective predetermined value (e.g., a maximum width and height of the multimodal machine learning model).

As one example, converting the image item to one or more sequences of image frames can comprise: obtaining a mask for selecting portions of the image item; and generating, from the image item, one or more video items comprising a respective one or more sequences of image frames, each image frame comprising a respective portion of the image item selected using the mask, wherein for each image sequence the mask is translated incrementally over the image item (e.g., along a first direction) to select the respective portions of the image item for successive image frames in the sequence.

As one example, converting the image item to a sequence of image frames may comprise: resizing the image item such that a first dimension of the resized image item is less than or equal to a corresponding first dimension of a mask for selecting a portion of the resized image item; and generating the sequence of image frames from the resized image item. Each image frame may comprise a respective portion of the resized image item selected using the mask, wherein the mask is translated incrementally along a second dimension of the resized image item for successive frames in the sequence. In some implementations, the image frames may be partially overlapping, which may improve the performance of the machine learning task by the machine learning model in at least some cases. Alternatively, in some implementations, there can be no overlap between the image frames.

According to a third aspect of the present disclosure, there is provided a method performed by one or more data processing apparatus for performing a machine learning task using a machine learning model. The method comprises: receiving an image item (e.g., an image captured by one or more sensors); resizing the image item such that a first dimension (e.g., a width or a height) of the resized image item is less than or equal to a corresponding first dimension of a mask (e.g., a square or rectangular mask) for selecting a portion of the resized image item; generating, from the resized image item, a video item comprising a sequence of image frames, each image frame comprising a respective portion of the resized image item selected using the mask (e.g., a “crop” of the image). The mask is translated incrementally along a second dimension of the resized image item for successive image frames in the sequence. The method further comprises performing a machine learning task by processing the video item using a machine learning model.

The third aspect can, in some implementations, additionally include the steps and features described above for the first and second aspects.

The second dimension of the resized image item may be greater than the second dimension of the mask. The video item may comprise any appropriate integer number of image frames greater than one, more than two image frames, more than five image frames, or more than ten image frames (e.g., 2, 3, 4, 5, 10, 20, 100 image frames etc.). Processing the video item may comprise providing the machine learning model with a model input comprising the image frames and data indicative of the image frames belonging to a video item (as opposed to an image item).

The first dimension of the resized image item may correspond to a smaller of the first and second dimensions of the image item. For example, where a width of the image item is greater than a height of the image item (e.g., the image item has a “landscape” orientation), the first dimension may correspond to the height of the image item. Conversely, if the width is less than the height (e.g., the image item has a “portrait” orientation), the first dimension may correspond to the width. The dimensions of the mask may be selected according to a maximum width and height of image items that the machine learning model is configured to process. For example, the mask may have a width and height equal to the maximum width and height of the machine learning model.

Resizing the image item may preserve an aspect ratio of the image item. Where the first dimension of the resized image item is less than the corresponding first dimension of the mask, the resized image item may be padded with a default or null value to make the first dimension of the resized image item and the first dimension of the mask equal. In some implementations, the image item or mask may be rotated or transposed prior to resizing, e.g., such that the smaller dimension of the image item corresponds to the smaller dimension of the mask. Resizing the image item may be referred to as image scaling or image resampling (e.g., downsampling), and can be performed with many common image processing libraries, such as OpenCV or scikit-image.

In some implementations, the mask is translated along the second dimension of the resized image item in increments equal to a length of the mask along the second dimension of the resized image item. The portions of the resized image item of each of the image frames may collectively span the entire resized image item (e.g., the image frames may “tile” the resized image item), or only a region of the resized image item. The resized image item may be padded with a default or null value along the second dimension of the image item, e.g., such that a predetermined number of image frames can be generated by translating the mask along the second dimension of the resized image item. In some implementations, the image item may be resized such that the second dimension of the resized image is equal to an integer multiple (e.g., 4) of the second dimension of the mask.

In some implementations, the sequence of frames comprises one or more pairs of image frames. Each pair of image frames comprises a respective first image frame and a respective second image frame adjacent in the sequence to the first image frame, wherein the respective portions of the resized images of the first and second image frames overlap along the second dimension of the resized image. Such overlapping may improve the performance of the machine learning model by allowing the machine learning model to better take into account features of the image item that span more than one of the image frames, for example. As one example, the image item may be an image comprising text formatted as a table (i.e., tabular data) and the image frames may comprise different respective portions (e.g., rows or columns) of the table. By overlapping the image frames, the machine learning model may be better able to identify that the rows or columns are part of the same table, rather than separate tables.

In some implementations, the machine learning model is a multimodal machine learning model that processes an input including a first modality input comprising the video item and a second modality input that represents a text, audio, or video item. The second modality input may represent one or more text items and the machine learning model is a vision language model configured to generate a joint embedding representing the video item and the one or more text items, and to use the joint embedding to perform the machine learning task.

In some other implementations, the machine learning model is a multimodal machine learning model that is configured to perform the machine learning task by processing an (input) image item if the size of the image item is less than or equal to a predetermined size. In such cases, it may be that no video item is generated, although if one or more are generated, the image item may be processed by the multimodal machine learning model together with the video item(s), which may improve the performance of the machine learning task by the multimodal machine learning model.

For example, the machine learning model may be a multimodal machine learning model that is configured to process, depending on a model input provided to the machine learning model, a first modality input representing an image item and/or a second modality input representing a video item. If a size of the image item is less than (or in some cases, equal to) a predetermined size, the model input may include the image item as a first modality input. If the size of the image item exceeds (or in some cases, is equal to) the predetermined size, the model input may include the video item as a second modality input. In other words, the machine learning model may perform different processing depending on whether the model input comprises an image item and/or a video item generated from the image item. In some implementations, the size of the image item may be determined to be less than a predetermined size if a width and/or height of the image item is less than a predetermined value.

For any of the first aspect, the second aspect, and the third aspect, the machine learning task may comprise one or more of: an object or action detection task, a classification task, a captioning task, a question-answering task, a natural language translation task, a character or word recognition task, an image or audio generation task, or a computer language generation task. The image item may comprise an image of a document and an output of the machine learning task may be dependent on text and/or one or more images (e.g., graphics or charts) in the document. The document may, for example, be one or more of: a web page, an infographic, a form (e.g., an order form with details of items and/or services to be purchased), a map (e.g., of a geographic area or building), a receipt (e.g., a receipt listing purchased items), photographic film (e.g., a roll or spool of photographic film), and design drawings (e.g., blueprints or architectural drawings, circuit diagrams) of an object or building. The document may also comprise a screenshot of an image displayed on the display of a computer system.

In some implementations, the image item is an image of a scene comprising a plurality of objects arranged along a direction corresponding to the second dimension of the image item and the machine learning task comprises identifying (and optionally, counting) one or more of the objects. For example, the objects may be items arranged on shelves of a supermarket, a warehouse or a factory. The model output may then, for example, comprise an inventory of the objects. Processing the image item as a video item may allow the machine learning model to more accurately identify and/or count the one or more objects.

In some implementations, the machine learning task comprises an agent control task, wherein an agent interacts with an environment to perform the agent control task, wherein the image item comprises an observation of the environment, and wherein an output of the machine learning model is used to select one or more actions to be performed by the agent in the environment in response to the observation. The environment may be a real-world environment or a simulated environment. The machine learning model may be trained in a simulated environment and then deployed in a real-world environment, for example.

According to a further aspect of the present disclosure, there is provided one or more non-transitory computer storage media storing instructions that when executed by one or more computers cause the one or more computers to perform operations of the respective method of the first aspect or the second aspect.

According to a further aspect of the present disclosure, there is provided a system comprising: one or more computers; and one or more storage devices communicatively coupled to the one or more computers, wherein the one or more storage devices store instructions that, when executed by the one or more computers, cause the one or more computers to perform operations of the respective method of the first aspect or the second aspect.

The system may additionally comprise an image sensor (e.g., camera or scanner) configured to obtain an image item and provide the image item to the one or more computers for performing the machine learning task.

The subject matter described in this specification can be implemented in particular embodiments so as to realize one or more of the following advantages.

Processing the video item using the machine learning model may comprise processing the image frames sequentially, either individually or in batches comprising two or more image frames. As each image frame is generally smaller than the received image item, the (instantaneous) amount of memory resources required to process the video item may be less than if the image item is processed by the machine learning model as a (single) image item (as opposed to a video item). In some cases, some (e.g., batches) of the image frames may be processed in parallel.

In general, the machine learning model may be configured to receive image items of less than a maximum size, i.e., a maximum width and height (specified as a number of pixels, such as 768×768 pixels, 800×600 pixels, 1024×1024 pixels, etc.). In some existing image processing methods, image items are therefore resized such that both the width and height of the resized image are less than the maximum width and height, in order to allow them to be processed by the machine learning model. However, such resizing (resampling) may decrease the amount of information available to the machine learning model, resulting in relatively poor performance of the machine learning task, particularly for image items that have very different widths and heights, i.e., low or very high aspect ratios (or where the maximum width and height of the machine learning model are very different). As described herein, the amount of information lost as a result of resizing the image item may be decreased. For example, for an image item that has a width that is much greater than its height (e.g., a landscape or panoramic image), the image item may be resized such that the height of the resized image item is less than or equal to the maximum height that can be processed by the machine learning model, while the width of the resized image item remains greater than the maximum width that can be processed by the machine learning model. In that case, each of the image frames of the video item may have a width that is less than or equal to the maximum width that can be processed by the machine learning model, with the image frames collectively spanning the width of the resized image item. Thus, more of the information in the image item can be retained, whilst still allowing processing of the resized image item by the machine learning model.

Improved performance of the machine learning model can also be achieved by using a mask size that is less than the maximum size of image items that can be processed by the machine learning model and then resizing each of the image frames to the maximum size of image items that can be processed by the machine learning model. The machine learning model may, for example, be better able to attend to features of the image frames as a result of the size of the image frames being increased.

In general, the machine learning model may be a neural network model with a plurality of learnable parameters, such as weights, that are updated during training. Such a neural network model can have any appropriate architecture, such as an attention-based neural network architecture, e.g., a transformer architecture, a convolutional architecture, a fully-connected architecture, or any other appropriate neural network architecture. The model can include any appropriate types of neural network layers, e.g., convolutional layers, attention layers, fully connected layers, recurrent layers, and so forth, in any appropriate numbers, e.g., 10 layers, 100 layers, or 1000 layers, and connected in any appropriate configuration, e.g., as a linear sequence of layers or as a directed graph of layers. Some implementations of the models described herein can be described as “large” multimodal models, e.g., with more than 10¹⁰ learnable parameters, but applications of the described techniques are not restricted to such models.

In general, a multimodal machine learning model has a multimodal input configured to receive a first multimodal input and a second multimodal input (and optionally, one or more further multimodal inputs). As used herein a “modality” refers to a type of data, and thus a multimodal machine learning model is one that can process multiple different types of data. In some implementations, there may be more than two different multimodal inputs, each configured to receive a different type of data.

For example, the first multimodal input may be configured to receive an image item, which may comprise image data defining color or intensity values for pixels of an image. As used herein “image” (image item) includes a point cloud (e.g., a LIDAR point cloud), and the image data may also or instead define the locations of points of a point cloud. The second multimodal input may be configured to receive a video item. The video item may comprise image data defining color or intensity values for pixels for each image frame in a sequence of image frames (i.e., two or more image frames having a specified order). The video item may be generated from an image item, e.g., such that each image frame of the sequence comprises a respective portion of the image item. The model input may, optionally, include one or more further multimodal inputs, e.g., a text input. An image item can comprise a standalone image, a part (e.g., patch) of an image, a frame of a video item, and so on.

As another example, the first multimodal input may be configured to receive an image item and the second multimodal input may comprise a text input configured to receive a sequence of text. The text may comprise text in one or more natural languages, or text in a computer language, or both. The computer language may be any formal language used to communicate with a computer, e.g., a markup language, or a command or configuration language, or a data exchange language such as JSON, or a programming language. The text may be received, e.g., as a series of encoded characters, e.g., UTF-8 encoded characters; such “characters” can include Chinese and other similar characters, as well as logograms, syllabograms and the like. The text may comprise instructions and/or context data for performing the machine learning task. In some cases, the text may comprise transcribed speech.

The multimodal machine learning model can include one or more multimodal input encoders configured to process one or more of the multimodal inputs, e.g., using one or more convolutional, attention, fully connected, or recurrent layers, to generate an encoded version of the multimodal input. In general such an encoder may implement any form of encoding appropriate for the type of data to be encoded. Where the multimodal input comprises an image or video this may be encoded, e.g., as a sequence of visual tokens selected from a vocabulary of visual tokens, or as a representation of distinct objects in the visual input. Where the multimodal input comprises a text input, the machine learning model can include a text encoder that processes the sequence of text to represent the text as a series of text tokens from a vocabulary of text tokens, e.g., that each represent words, wordpieces or characters in a natural or computer language. Visual tokens may, but need not be, interleaved with text tokens processed by the model.

The multimodal machine learning model may be configured to jointly process an encoded version of a text sequence and an encoded version of another multimodal input, e.g., of an image or video, to generate a model output that defines a result of the machine learning task. The multimodal machine learning model may be a vision language model.

The model output may comprise any form of output appropriate to the machine learning task performed by the machine learning model. For example the model output may comprise text in a natural or computer language that defines a result of the task, e.g., for tasks such as image captioning, visual question answering, or object detection or instance segmentation. Also or instead, the model output may comprise data defining an image, video or audio object, e.g., in a generative task; or the model output may comprise non-textual action selection data for selecting an action to be performed by an agent controlled by the model. As another example the model output may also or instead define an intermediate step to be performed during the task, e.g., a call to a software API for a software tool that is used when performing the task; the multimodal input may then receive an output from the software tool that is used to generate a final model output that performs the task. The model output may be multimodal in some instances.

Such a multimodal machine learning model can be trained using very large (but possibly noisy) datasets in which text is paired with an image and/or with one or more other types of data, e.g., audio data, or data relating to the operation of an agent acting in an environment to perform a variety of tasks. Such a model can be trained, e.g., using self-supervised learning. The pairing can often be imperfect, and the training dataset can, but may not, include any actual examples of a particular task to be performed, but nonetheless an ability to perform a particular task can emerge. There are many examples of suitable, publicly available training datasets.

Some example multimodal machine learning models with which the techniques described herein may be used include: Flamingo (Alayrac et al. arXiv: 2204.14198); ALIGN (Jia et al., arXiv: 2102.05918); PaLI (Chen et al. arXiv: 2209.06794); PaLI-X (Chen et al. arXiv: 2305.18565); and MIRASOL3B (Piergiovanni et al. arxiv 2311.05698).

The details of one or more embodiments of the subject matter of this specification are set forth in the accompanying drawings and the description below. Other features, aspects, and advantages of the subject matter will become apparent from the description, the drawings, and the claims.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic view of a pre-processor system.

FIG. 2A is a view of an example image item showing locations of a mask for obtaining a sequence of image frames.

FIG. 2B is a schematic view of a sequence of image frames obtained from the image item of FIG. 2A using the locations of the mask in FIG. 2A.

FIG. 3A is a view of the image item of FIG. 2A showing locations of another mask.

FIG. 3B is a schematic view of a first sequence of image frames obtained from the image item of FIG. 2A using the locations of the mask of FIG. 3A.

FIG. 3C is a schematic view of a second sequence of image frames obtained from the image item of FIG. 2A using the locations of the mask of FIG. 3A.

FIGS. 4A and 4B are flow diagrams of a process for performing a machine learning task.

FIGS. 5A and 5B are flow diagrams of another process for performing a machine learning task.

Like reference numbers and designations in the various drawings indicate like elements.

### DETAILED DESCRIPTION

The systems and methods described in this specification can improve the ability of a machine learning model to perform a machine learning task by converting an image item into one or more video items for processing by the machine learning model instead of, or in addition to, the image item.

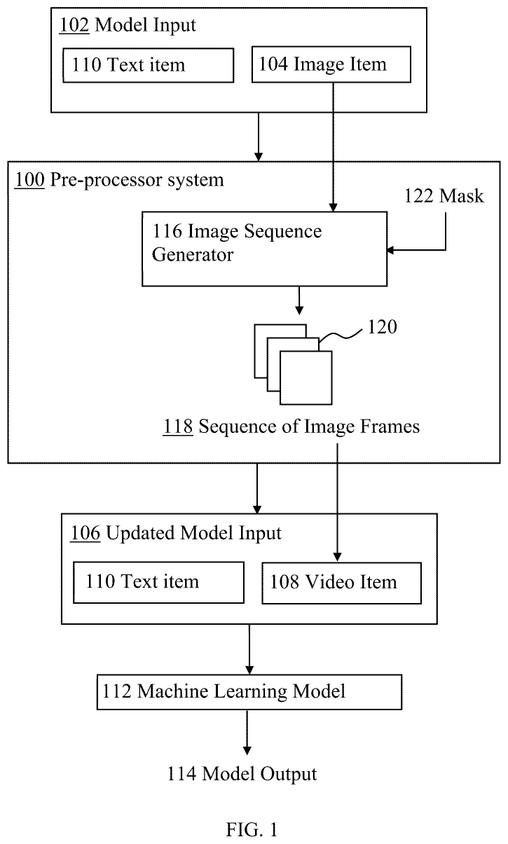

FIG. 1 shows a pre-processor system 100, which is an example of a system implemented as computer programs on one or more computers (data processing apparatus) in one or more locations in which the systems, components, and techniques described below are implemented.

The pre-preprocessor system 100 is configured to receive a model input 102 comprising an image item 104 and process the model input 102 to generate an updated model input 106 comprising a video item 108 (or more than one video items). The video item 108 can, for example, replace the image item 104 in the updated model input 106, or else be provided in addition to the image item 104 in the updated model input 106. The model input 102 and the updated model input 106 can additionally, as in the present example, comprise one or more input items other than the image item 104, e.g., a text item 110.

The updated model input 106 can be processed by a machine learning model 112 to perform a machine learning task that generates a corresponding model output 114 based on the updated model input 106. In general, the machine learning task can be any machine learning task that can be performed using the model input 102 or the updated model input 106. As one example, the machine learning vision language model 112 can be a vision language model configured to generate a joint embedding representing the video item 108 (or the image item 104) and the text item 110, and to use the joint embedding to perform the machine learning task, such as an object recognition or image classification task.

The pre-processor system 100 comprises an image sequence generator 116 that is configured to process the image item 104 to generate one or more sequences 118 of image frames 120 using a mask 122. Each image frame 120 comprises a respective portion of the image item 104 selected using the mask 122. The image sequence generator 116 is configured to translate the mask incrementally (step-wise) over the image item 122 to select the respective portions of the image item 104 for successive image frames 120 in each sequence 118. For example, the image sequence generator 116 can be configured to translate the mask 122 over the image item 104 along a first direction to select the respective portions of the image item 104 for successive image frames 120 in each sequence 118. Each image frame comprises a different respective crop of the image item (i.e., a different respective region of the image item) obtained using the mask.

In some implementations, the mask 122 can be rectangular (e.g., square) with fixed dimensions (e.g., width and height) such that the same mask 122 is used for different image items 104. In such cases, the image item 104 can, for example, be resized such that a first dimension (e.g., a width or a height) of the resized image item is less than or equal to a corresponding first dimension of the mask 122. That is, the image item can be resized such that the mask spans or exceeds the width or the height of the image item.

Alternatively, the dimensions of the mask 122 can be determined by the pre-processor system 100 based on the image item 104, e.g., based on the dimensions of the image item 104. That is, the dimensions of the mask 122 can be adapted to the image item 104. As one example, the dimensions of the mask 122 can be determined based on a minimum of the width and the height of the image item 104. For example, the width and/or height of the mask can be equal to a minimum of the width and the height of the image item 104 divided by a scaling factor greater than one. The dimensions of the mask 122 can additionally be required to have at least a minimum value (i.e., a minimum width and/or height), in some examples.

In some implementations, the pre-processor system 100 can be configured to generate the one or more video items 108 only if the image item 104 meets one or more pre-determined criteria, e.g., criteria based on one or both of the dimensions of the image item, and/or an aspect ratio of the image item 104. For example, the pre-processor system 100 can be configured to generate the one or more video items 108 if either the width or the height of the image item 104 exceeds a pre-determined first threshold and/or an aspect ratio of the image item 104 exceeds a pre-determined second threshold.

If the image item 104 does not meet the one or more criteria, then the pre-processor system 100 can provide the model input 102 (rather than an updated model input 106) to the machine learning model 112 for performance of the machine learning task.

In some implementations, the image frames 120 can be resized, e.g., to have the same dimensions as a maximum or minimum image size that can be processed using the machine learning model 112. Any image resizing (scaling) technique can be used to resize the image item 104 or image frames 120, e.g., nearest-neighbour interpolation, bilinear interpolation, spline interpolation, a Fourier-transform-based scaling method, a neural network scaling method, and so on.

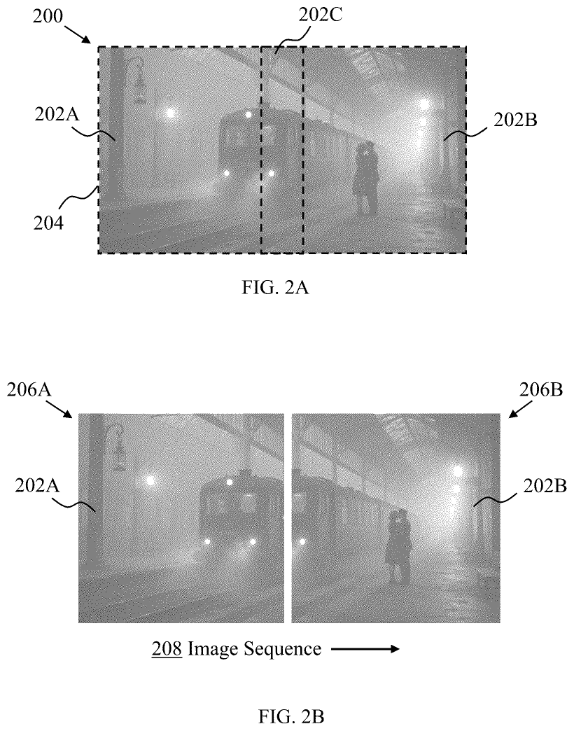

FIG. 2A shows an exemplary image item 200, which in this case depicts a scene of a physical environment. For this example, the machine learning task may be to detect one or more objects in the scene, or to classify the scene, or to determine a sequence of actions for a robotic agent to perform an agent control task (e.g., a manipulation task or a navigation task) in the physical environment, and so on. The image item 200 is divided into first and second image portions (regions) 202A, 202B obtained by translating a mask 204 over the image item 200 from left to right, i.e., across the width of the image item 200. In this example, the first and second image portions 202A overlap such that successive (i.e., the first and second) image portions 202A, 202B each comprise a common region 202C of the image item 200. In this example, the mask 204 spans the full height of the image item 200 such that the image item 200 can be covered using a single row of image portions 202A, 202B.

FIG. 2B shows an image sequence 208 that includes a first image frame 206A comprising the first image portion 202A and a second image frame 206B comprising the second image portion 202B. The image sequence 208 can be processed by the machine learning model 112 of FIG. 1 as a video item. Including the common region 202C of the image item 200 in each of the first and second image frames 206A, 206B can improve the ability of the machine learning model 112 to reason about the scene depicted in the image item 200 using the image sequence 208.

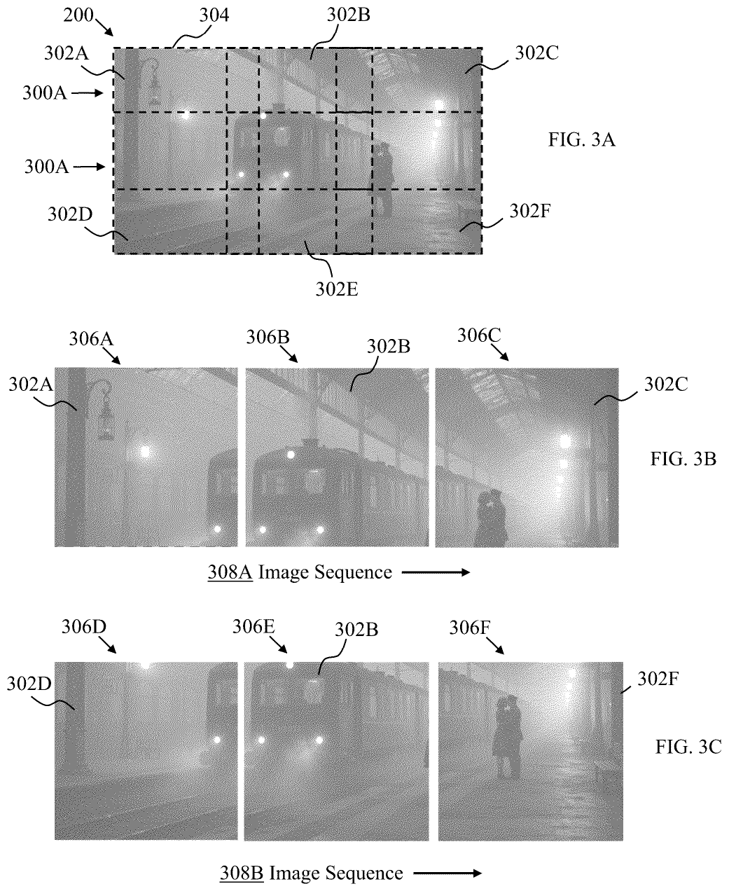

FIG. 3A shows the image item 200 of FIG. 2A, a first row 300A of image portions 302A-C of the image item 200, and a second row 300B of image portions 302D-F of the image item 200. The image portions 302A-D in each of the rows 300A, 300B are obtained by translating another mask 304 across the image item 100. In this example, the mask 304 does not span the full height of the image item 200 such that two rows 300A, 300B of image portions 302A-F are required to cover the image item 200, with the second row 300B of image portions 302D-F being offset vertically from the first row 300A of image portions 302A-C. As in FIG. 2A, successive image portions 302A-C, 302D-F in each of the first and second rows 300A, 300B overlap horizontally. Furthermore, in this example, the image portions 302D-F of the second row 300B overlap vertically with the image portions 302A-C of the first row 300A.

FIG. 3B shows a first image sequence 308A that comprises a plurality of image frames 306A-C, each image frame comprising a respective one of the image portions 302A-C of the first row 300A of image portions of FIG. 3A.

FIG. 3C similarly shows a second image sequence 308B that comprises a plurality of image frames 306D-F, each image frame comprising a respective one of the image portions 302D-F of the second row 300B of image portions of FIG. 3A. The image frames 306D-F of the second image sequence 308B are obtained by translating the mask 304 across the image item 200 along the same direction that was used to obtain the image frames 306A-C of the first image sequence 308A. However, the image frames 306D-F of the second image sequence 308B can alternatively be obtained by translating the mask 304 along the opposite direction from the direction used to obtain the image frames 306A-C of the first image sequence 308A. As another example, the image frames of the image sequences can be obtained by translating a mask over the image item along more than one direction, e.g., along a path having components in two perpendicular directions. For example, the path can be one of: a row-major or column-major raster scan, an outwardly or inwardly spiraling path, a snake-like or winding path e.g., a continuous path comprising sections (e.g., rows of columns) of opposite directions, and so on. In some examples, an image sequence can be generated by translating the mask along a path that covers the whole of the image item, such that the image sequence comprises image frames that collectively cover the whole of the image item. Translating the mask over the image item can therefore comprise performing a 1D or 2D “scan” of the image item.

The first and second image sequences 308A, 308B can be provided to the machine learning model 112 in a single video item 108, or in respective first and second video items.

It will be appreciated that more image portions, and optionally more rows of image portions, can be obtained using a smaller mask or by increasing the amount of overlap between the image portions in each row, or between the image portions in successive rows. For example, each image sequence can comprise more than two image frames, more than three image frames, more than five image frames, and so on. One or more (e.g., all) of the image sequences can be provided in a single video item in some examples.

Whilst FIGS. 2A and 2B and FIGS. 3A and 3B have exemplified processing a landscape image item 200, it will be appreciated that portrait image items can be processed in an analogous manner, e.g., by translating a mask vertically over the image item so as to generate one or more columns of image portions from which e.g., respective image sequences can be obtained. Similarly, for practical reasons, the exemplary image items shown in the figures are 2D images, but it will be appreciated that the systems and methods described in this specification can also be applied to 3D image items, e.g., image items that characterize a 3D volume of a physical environment captured using one or more sensors (e.g., a LIDAR camera or camera array) in the physical environment. For example, the mask can define a 3D region, which is translated through the 3D volume to obtain one or more sequences of 3D image frames, i.e., the one or more sequences of image frames can be obtained by “scanning” the mask through the 3D volume. The machine learning model can, for example, process the 3D video item(s) to better reason about the physical environment.

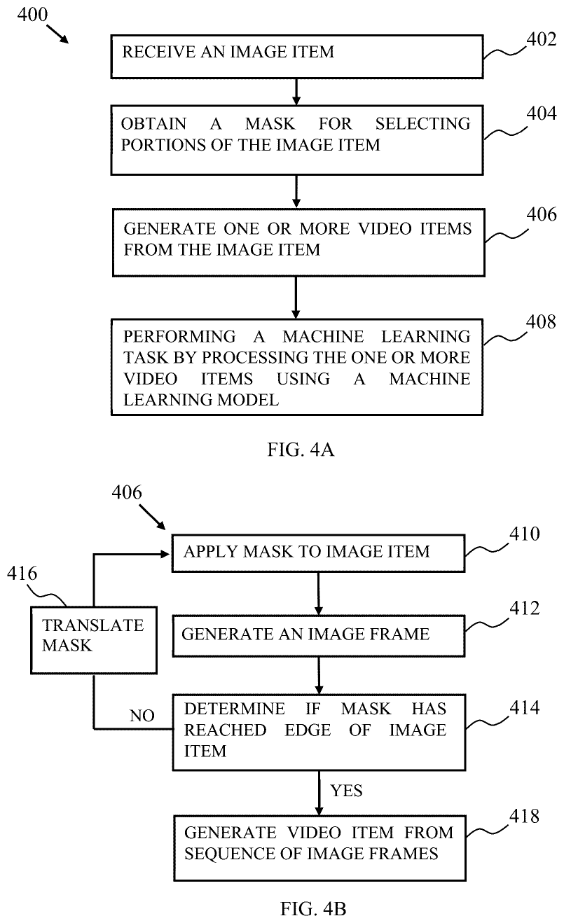

FIG. 4A shows a process 400 which can be performed by one or more data processing apparatus (computers). For example, the process can be implemented by a pre-processor system and machine learning model as shown in FIG. 1.

The process 400 comprises receiving an image item (step 402) and obtaining a mask for selecting portions of the image item (step 404). The system then generates one or more video items from the image item (step 406). The process 400 further comprises performing a machine learning task by processing the one or more video items using the machine learning model. Examples of machine learning tasks are described below.

FIG. 4B shows how the step 406 of generating the one or more video items from the image item can be performed. The mask is applied to the image item (step 410), e.g., by selecting an initial position for the mask relative to the image item. An image frame is then generated (step 412) by cropping the image item using the mask. A determination is then made (step 414) as to whether the mask has reached an edge of the image item. If the mask has not reached an edge of the image item then the mask is translated (step 418) along a first direction (e.g., horizontally or vertically), and the steps 410-414 repeated. Once the mask has reached the edge of the image item, a video item is generated from the sequence of image frames resulting from repeatedly performing steps 410-414.

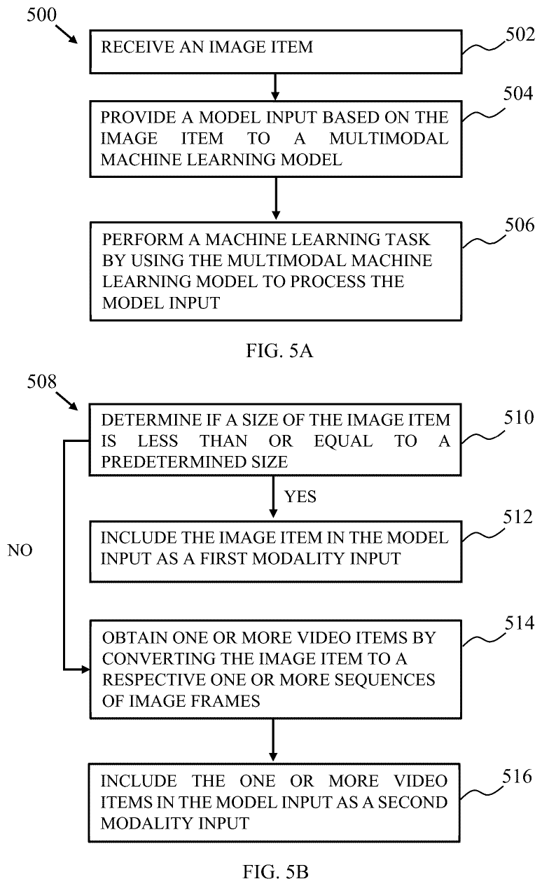

FIG. 5A shows another process 500 which can be performed by one or more data processing apparatus. For example, the process can be implemented by a pre-processor system and machine learning model as shown in FIG. 1.

The process 500 comprises receiving an image item (step 502), providing a model input based on the image item to a multimodal machine learning model (step 504) and performing a machine learning task by using the multimodal machine learning model to process the model input.

FIG. 5B shows a sub-process of the step 504 of providing the model input based on the image item to a multimodal machine learning model. The sub-process comprises determining if a size of the image item is less than or equal to a pre-determined size (step 510). If the size of the image item is less than the predetermined size, the model input includes as a first modality input (step 512). For example, the size of the image item can be determined to be less than the pre-determined size if a width of the image item is less than a predetermined width and a height of the image item is greater than a predetermined height. If the size of the image item exceeds the predetermined size, a step 514 of obtaining one or more video items by converting the image item to a respective one or more sequences of image frames is performed. Each image frame comprises a respective portion of the image item. The one or more video items are then included in the model input as a second modality input (step 516).

In general, the machine learning task performed by the machine learning model may comprise one or more of the following examples of machine learning tasks.

For some tasks, the multimodal input represents an image or video generated from an image, as previously described. The image may be obtained from a camera or other imaging device that captures the image from a real-world environment. In general the tasks described below may be tasks that require spatial awareness or other context from the image item. For example, a prompt may ask “What is the object in the top left corner?”

As one example the task may comprise an object or action detection task. A task-specific training data item may comprise an image or video item containing one or more objects or actions (e.g., an image of a scene in which one or more actions are being performed), and a sequence of text. The sequence of text may describe or otherwise label the object(s) or action(s) and may include text giving bounding box coordinates for the object(s) or action(s). After training, when the model is used in inference, the model output may comprise or represent text that describes or otherwise labels detected object(s) or action(s) in the image, and may include bounding-box coordinates for the detected object(s) or action(s), e.g., “10 20 90 100 cat 20 30 100 100 dog”.

As another example the task may comprise a classification task, e.g., an object or action classification task. A task-specific training data item may comprise an image or video item containing one or more objects or actions and a sequence of text. The sequence of text may describe or otherwise classify the object(s) or action(s). After training, when the model is used in inference, the model output may comprise data, e.g., text that classifies the object(s) or action(s) in the image item into one of a plurality of classes.

As another example the task may comprise an image item describing task, e.g., a captioning task (which, as used here, includes an audio description task to explain what is shown in the image). A task-specific training data item may comprise an image item (and/or a video item generated from an image item) and a sequence of text describing the image item. After training, when the model is used in inference, the model output may comprise data, e.g., text, describing the image item. For example the model output may provide a caption or description of the image item, or it may count objects in the image item, or it may provide some other form of description of the image item.

As another example the task may comprise an image question-answering task. A task-specific training data item may comprise an image item (and/or video item generated from an image item) and a sequence of text that describes the image item. After training, when the model is used in inference, the model output may comprise data, e.g., text, that answers a question about the image item specified in a prompt sequence of text, e.g., as described above. This may be used, e.g., to answer questions about visual plots and charts.

As another example the task may comprise a character or word recognition task, e.g., an OCR (optical character recognition) task. A task-specific training data item may comprise an image item (and/or video item generated from an image item) and a sequence of text that includes text that is depicted in the image. After training, when the model is used in inference, the model output may comprise text that represents characters or words in the input image item, e.g., in a natural language.

As another example the task may comprise a still or moving image generation task. A task-specific training data item may comprise an image item (and/or video item generated from an image item) and a sequence of text that describes the image item. After training, when the model is used in inference, the model output may comprise data for an image or video item, e.g., image data defining values for pixels of a still or moving image, and the sequence of text in the multimodal input to the model may describe or characterize the image or video item to be generated.

As another example the task may comprise a computer language text generation task. A task-specific training data item may comprise an image or video item, and a sequence of text in a computer language for generating an image, video, or audio item. After training, when the model is used in inference, the model output may comprise text in the or another computer language for generating or rendering an image, video, or audio item, e.g., a web page, plot, or chart.

In another example of a computer language text generation task a task-specific training data item may comprise an image item (and/or video item generated from an image item) and a sequence of text in a computer language for performing a task in relation to the image item, e.g., a data processing task that involves analyzing the content of the image item to provide a result of the analysis or, e.g., a search to search for information relating to the content of the image or video item. The computer language in the model output may comprise computer language for invoking a function or calling one or more external APIs. Merely as one example, such an output may be formatted as a JSON object. As previously, the sequence of text in the multimodal input may define the task to be performed in relation to an input image item (and/or video generated from an input image item). For example, the task may involve manipulation of particular types of data that may benefit from access to an API such as mathematical data, date/time related data, scientific data, recent data that may post-date training of the model (that may be accessed by a search function or API), and so forth. After training, when the model is used in inference, the model output may comprise text in the or another computer language for performing a task, e.g., as described above, in relation to the image or video item. The method may then include using the text in the computer language to perform the task.

In general where the model output comprises text this may be provided as speech representing the text.

In some implementations, the machine learning task comprises an agent control task in which the agent interacts with an environment to perform the agent control task. In these implementations, the model input includes an image item comprising an observation characterizing the environment, e.g., captured by a camera or other imaging device from a real-world environment. The model input can additionally include a sequence of text that defines the task to be performed by the agent.

A task-specific training data item may comprise a sequence of text representing one or more actions of the agent, and an image item comprising an observation characterizing the environment (and optionally, other or the same modality data comprising an observation of the environment). After training, when the machine learning model is used in inference, the model output comprises an action selection output, e.g., including text, that is used to select one or more actions to be performed by the agent in the environment in response to the observation. As an illustration the model output may define an action as text such as “A: 132 114 128 5 25 156”, that can be converted into a control signal for a mechanical agent, such as a robot, e.g., “ΔT=[0.1, −0.2,0]ΔR=[10°, 25°, −7°]”. As another example the action selection output may also or instead define one or more low-level skills, e.g., from a vocabulary of previously learnt skills. As before, the sequence of text in the multimodal input to the model may describe the task to be performed, e.g., “What action should the robot take to [perform task]”.

In some agent control implementations, the environment is a real-world environment and the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot or other mechanical agent interacting with the environment to accomplish a specific task, e.g., to locate or manipulate an object of interest in the environment or to move an object of interest to a specified location in the environment or to navigate to a specified destination in the environment. In these implementations, the observations may include, e.g., one or more of: images, object position data, and sensor data to capture observations as the agent interacts with the environment. The actions may define control signals to control the robot or other mechanical agent, e.g., positions, torques, or other control signals for the parts of the mechanical agent, or higher-level control commands.

In some agent control implementations the agent can be a software agent, i.e., a computer program, configured to perform a task. Some examples where the agent is a software agent now follow.

As one example the environment may be an integrated circuit design and the task may be a routing task for routing interconnection lines of the integrated circuit. The observations may be of component positions and/or interconnections, and the actions may comprise component placing or interconnect routing actions. An integrated circuit with interconnection lines routed as determined may then be fabricated.

As another example the environment may be a real-world computing environment and the task may be to manage the distribution of jobs or tasks across computing resources, e.g., on a mobile device and/or in a data center. The observations may include observations of computing resources such as compute or memory capacity, or Internet-accessible resources, or that relate to the operation of the computing resources in processing the jobs or tasks; and the actions may include assigning jobs or tasks to particular computing resources.

As another example the environment may be a real-world computing environment and the task is to manage the processing, e.g., by one or more real-world servers, of a queue of continuously arriving jobs. The observations may comprise observations of the times of departures of successive jobs, or the time intervals between the departures of successive jobs, or the time a server takes to process each job, or the arrival times, or time intervals between the arrivals, of successive jobs, or data characterizing the type of job(s). The actions may comprise actions that allocate particular jobs to particular computing resources.

As another example the environment may comprise a real-world computer system or network and the task may be to maintain security of the computer system or network. The observations may comprise any observations characterizing operation of the computer system or network, and the actions may comprise actions to control the operation, e.g., to limit or correct abnormal or undesired operation, e.g., because of the presence of a virus or other security breach.

As another example the environment may comprise a data packet communications network environment, and the task may be to route packets of data over the communications network. The actions may comprise data packet routing actions and the observations may comprise, e.g., observations of a routing table which includes routing metrics such as a metric of routing path length, bandwidth, load, hop count, path cost, delay, maximum transmission unit (MTU), and reliability.

In some agent control implementations the agent may be a human agent and the environment may be a real-world environment. For example the agent can be a human user of a digital assistant such as a smart speaker, smart display, or some other device that is used to instruct the user to perform actions. The task may be any real-world task that the user wishes to perform. The observations may be obtained from an observation capture subsystem, e.g., a monitoring system such as a video camera or sound capture system, to capture visual and/or audio observations of the user performing the task. The actions may comprise instructions in the form of, e.g., text, image, video, or audio data such as speech, that guide the user in performing the task.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The essential elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more data processing apparatus, the method comprising:
receiving an image item;
obtaining a mask for selecting portions of the image item;
generating, from the image item, one or more video items comprising a respective one or more sequences of image frames, each image frame comprising a respective portion of the image item selected using the mask, wherein for each image sequence the mask is translated incrementally over the image item to select the respective portions of the image item for successive image frames in the sequence; and
performing a machine learning task by processing the one or more video items using a machine learning model.

2. The method of claim 1, wherein the mask is translated incrementally over the image item along a first direction to select the respective portions of the image item for successive image frames in the sequence.

3. The method of claim 2, wherein each sequence of image frames comprises one or more pairs of image frames, each pair of image frames comprising a respective first image frame and a respective second image frame adjacent in the sequence to the first image frame, wherein the respective portions of the image item of the first and second image frames overlap along the first direction.

4. The method of claim 2, wherein each video item comprises at least a first sequence of image frames and a second sequence of image frames, the respective portions of the image item for the image frames of the second sequence being offset along a second direction from the respective portions of the image item for the image frames of the second sequence.

5. The method of claim 1, wherein the machine learning model is configured to process, depending on a model input, a first modality input representing an image item and/or a second modality input representing one or more video items and wherein processing the one or more video items using the machine learning model comprises:
processing a model input comprising a second modality input representing the one or more video items using the machine learning model.

6. The method of claim 1, wherein the machine learning model is a multimodal machine learning model, the method further comprising, providing a model input to the machine learning model that comprises a first modality input for a modality other than video and a second modality input comprising the one or more video items.

7. The method of claim 6, wherein the first modality input represents one or more text items and the machine learning model is a vision language model configured to generate a joint embedding representing the video item and the one or more text items, and to use the joint embedding to perform the machine learning task.

8. The method of claim 1, wherein obtaining the mask comprises determining a size for the mask based on one or more of: an aspect ratio of the image item, a minimum dimension of the image item, and a maximum size of image frame that can be processed by the machine learning model.

9. The method of claim 1, further comprising resizing each image frame according to a maximum size of image frame that can be processed by the machine learning model.

10. The method of claim 1, further comprising, prior to generating the video item, resizing the image item such that a first dimension of the resized image item is less than or equal to a corresponding first dimension of the mask.

11. The method of claim 10, wherein the mask is translated incrementally over the image item along a first direction to select the respective portions of the image item for successive image frames in the sequence and the first direction is along a second dimension of the resized image.

12. The method of claim 10, wherein resizing the image item preserves an aspect ratio of the image item.

13. The method of claim 1, wherein the machine learning task comprises one or more of: an object or action detection task, a classification task, a captioning task, a question-answering task, a natural language translation task, a character or word recognition task, an image or audio generation task, or a computer language generation task.

14. The method of claim 1, wherein the image item comprises an image of a document and an output of the machine learning task is dependent on text and/or one or more images in the document.

15. The method of claim 14, wherein the document is one or more of: a web page, an infographic, a form, a map, a receipt, photographic film, or design drawings of an object or building.

16. The method of claim 1, wherein the image item is an image of a scene comprising a plurality of objects arranged along a direction corresponding to the second dimension of the image item and the machine learning task comprises identifying one or more of the objects.

17. The method of claim 1, wherein the machine learning task comprises an agent control task, wherein an agent interacts with an environment to perform the agent control task, wherein the image item comprises an observation of the environment, and wherein an output of the machine learning model is used to select one or more actions to be performed by the agent in the environment in response to the observation.

18. The method of claim 17, wherein the environment is a real-world environment.

19. One or more non-transitory computer storage media storing instructions that when executed by one or more computers cause the one or more computers to perform operations comprising:
receiving an image item;
obtaining a mask for selecting portions of the image item;
generating, from the image item, one or more video items comprising a respective one or more sequences of image frames, each image frame comprising a respective portion of the image item selected using the mask, wherein for each image sequence the mask is translated incrementally over the image item to select the respective portions of the image item for successive image frames in the sequence; and
performing a machine learning task by processing the one or more video items using a machine learning model.

20. A system comprising:
one or more computers; and
one or more storage devices communicatively coupled to the one or more computers, wherein the one or more storage devices store instructions that, when executed by the one or more computers, cause the one or more computers to perform operations comprising:
receiving an image item;
obtaining a mask for selecting portions of the image item;
generating, from the image item, one or more video items comprising a respective one or more sequences of image frames, each image frame comprising a respective portion of the image item selected using the mask, wherein for each image sequence the mask is translated incrementally over the image item to select the respective portions of the image item for successive image frames in the sequence; and
performing a machine learning task by processing the one or more video items using a machine learning model.
